(19) United States
(12) Patent Application Publication
(10) Pub. No.: US 2019/0193076 A1
(43) Pub. Date: Jun. 27, 2019

(54) MICROPLATE LID

(71) Applicant: HEWLETT-PACKARD DEVELOPMENT COMPANY, L.P., Houston, TX (US)

(72) Inventors: Christie DUDENHOEFER, Corvallis, OR (US); Jeffrey A. NIELSEN, Corvallis, OR (US); Kenneth WARD, Corvallis, OR (US); Matthew David SMITH, Corvallis, OR (US); Hilary ELY, Corvallis, OR (US)

(21) Appl. No.: 16/098,976

(22) PCT Filed: Jul. 14, 2016
(86) PCT No.: PCT/US2016/042210

§ 371 Date: Nov. 5, 2018

(51) Int. Cl. B01L 3/00

(52) U.S. Cl. CPC B01L 3/502715; B01L 2200/025; B01L 2200/0689; B01L 3/5085

(57) ABSTRACT

A microplate lid is disclosed. An electronics board includes a plurality of board throughholes corresponding to well locations of a microplate. A cover plate includes a plurality of plate throughholes corresponding to respective board throughholes to define a plurality of plate-board throughhole pairs. The cover plate is located atop the electronics board. A plurality of directing lumens is at least partially defined by the cover plate. Each directing lumen corresponds to a respective plate throughhole. A plurality of user-perceptible array indicators is provided to the electronics board. Each array indicator is associated with a different plate-board throughhole pair than every other array indicator.

### BACKGROUND

The ability to accurately measure and manipulate small fluid volumes is an important function in clinical and research laboratories. Drug discovery, immunoassays, molecular diagnostics, cancer research, cell and tissue engineering, and other life science-related work often involves the use of precious fluids and experiments in microtiter/microwell plates (these, and similar vessels, will be hereafter collectively referenced as “microplates”). Microplates provide an array of equal-sized microliter scale reaction vessels (hereafter, “wells”) which enable the user to conduct and compare the results of multiple small volume experiments simultaneously.

### BRIEF DESCRIPTION OF THE DRAWINGS

FIG. 1 schematically illustrates an exploded top view of an example of a microplate and microplate lid assembly.

FIG. 2 schematically illustrates an exploded partial cross section of a configuration of the example assembly of FIG. 1.

FIG. 3 schematically illustrates a partial cross section of a configuration of the example assembly of FIG. 1.

FIG. 4 schematically illustrates the example view of FIG. 3 in an example use environment.

FIG. 5 is a schematic detail view of area “5” in FIG. 4.

FIG. 6 schematically illustrates a top view of the example assembly of FIG. 1.

FIG. 7 schematically illustrates a bottom view of the example assembly of FIG. 1.

FIG. 8 is a schematic detail view of area “5” in FIG. 3 in a different configuration than that of FIG. 4.

FIG. 9 is a flowchart depicting an example sequence of use of the example assembly of FIG. 1.

### DETAILED DESCRIPTION

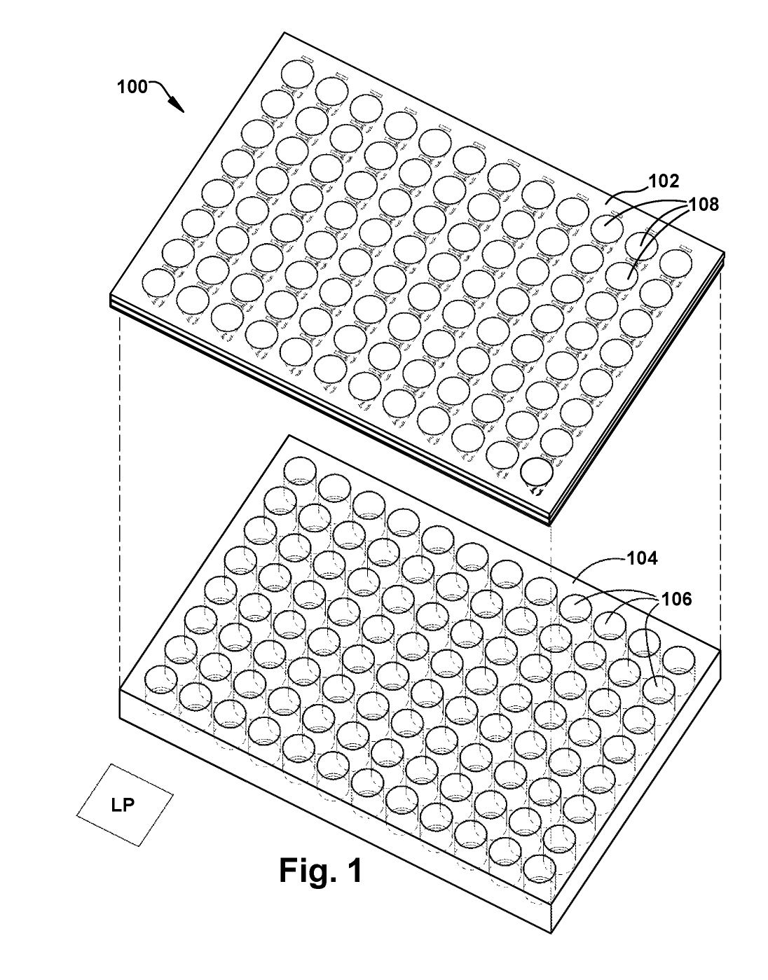

While a powerful tool, microplate experiments are often time-, labor-, and skill-intensive and may be susceptible to cross-contamination and loading errors (e.g. double-dosing, missed wells, and the like), potentially leading to inaccurate experiment results. FIG. 1 illustrates an exploded top view of an example assembly 100 including a microplate lid 102 and a microplate 104. The microplate 104 includes a plurality of wells 106 and may be of any suitable type. The microplate lid 102 includes a plurality of directing lumens 108. A plurality of directing lumens 108 (though not necessarily all of them on the microplate lid 102) each corresponds in position in the lateral plane (“LP”, in FIG. 1) to a selected one of the plurality of wells 106. It is contemplated that microplate lids 102 will be available in various configurations, each corresponding to a particular type (e.g., number of wells 106) of microplate 104.

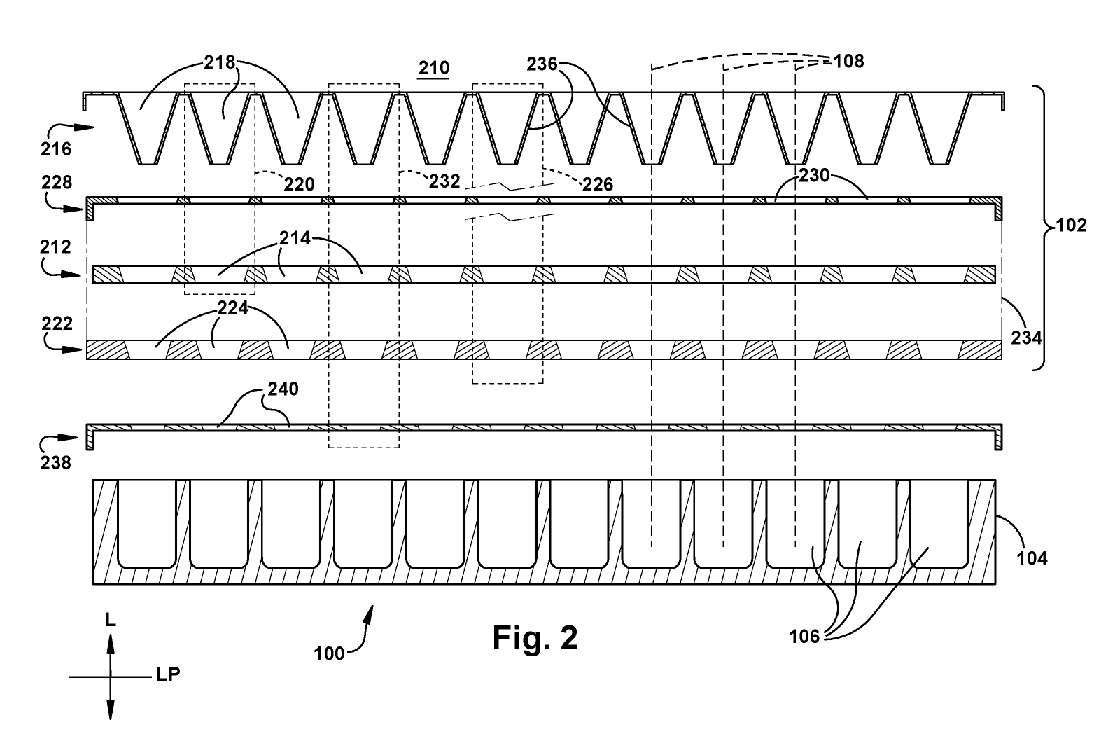

The assembly 100 is shown in a side view exploded depiction in FIG. 2. The dotted lines 108 representing the directing lumens in FIG. 2 illustrate the vertical or longitudinal alignment of the various features of the components of the assembly 100 to cooperatively provide fluid communication between the wells 106 and an ambient space 210. (The longitudinal direction “L” is perpendicular to the lateral plane “LP”.)

The microplate lid 102 includes an electronics board 212 including a plurality of board throughholes 214, with each board throughhole 214 corresponding to locations of the wells 106 of the microplate 104. That is, the board throughholes 214 are arranged in a predetermined array layout corresponding to well 106 locations of the microplate 104. The electronics board 212 may be parallel to the lateral plane LP. The electronics board 212 may be a wiring board, printed circuit board (“PCB”), or any other desired type of structure which supports electrical and/or electronic components, circuitry, or the like.

A cover plate 216 of the microplate lid 102 includes a plurality of plate throughholes 218, with each plate throughhole 218 corresponding to a respective board throughholes 214. Each set of corresponding plate and board throughholes 214 and 218 defines one of a plurality of plate-board throughhole pairs 220 (shown schematically via the encircling dashed line in FIG. 2) of the microplate lid 102. The plate-board throughhole pairs 220 are arranged in the predetermined array layout, previously mentioned, which corresponds to well 106 locations of the microplate 104. That is, the plate-board throughhole pairs 220 are aligned, and in fluid communication, with respective wells 106 of the microplate 104 when the microplate lid 102 is located atop the microplate 104. The cover plate 216 is located atop (i.e., longitudinally above), and can extend parallel to, the electronics board 212 as shown in FIG. 2. User-perceptible row and column labels (e.g., lettered rows and numbered columns) and/or individual well 106 labels, can be provided to the cover plate 216 and/or to any other structure of the microplate lid 102 to assist the user with accurately and repeatably identifying a particular well 106 from the array of wells 106 of the microplate 104.

A base plate 222 may be provided to the microplate lid 102. When present, the base plate 222 includes a plurality of base throughholes 224, with each base throughhole 224 corresponding to a respective plate-board throughhole pair 220 to define one of a plurality of plate-board-base throughhole stacks 226 (shown schematically via the encircling dashed line in FIG. 2, noted as being interrupted for implementations where the intermediate plate discussed below is absent). The plate-board-base throughhole stacks 226 are arranged in the predetermined array layout, previously mentioned, which corresponds to well 106 locations of the microplate 104. Each of the plurality of plate-board-base throughhole stacks 226 at least partially surrounds a respective directing lumen 108. The base plate 222 is located directly longitudinally beneath, and can extend parallel to, the electronics board 212.

An intermediate plate 228 may be provided to the microplate lid 102. When present, the intermediate plate 228 may include a plurality of intermediate throughholes 230, with each intermediate throughhole 230 corresponding to a respective plate-board-base throughhole stack 226 to at least partially define a plurality of lid throughholes 232 (shown schematically via the encircling dashed line in FIG. 2). The lid throughholes 232 are arranged in the predetermined array layout, previously mentioned, which corresponds to well 106 locations of the microplate 104. Each lid throughhole 232 at least partially defines a corresponding directing lumen 108. The intermediate plate 228 is interposed, or located, directly longitudinally between, and can extend parallel to, both the cover plate 216 and the electronics board 212.

A board cavity (shown schematically at 234 in FIG. 2) may be cooperatively defined by the intermediate plate 228 and the base plate 222. The board cavity 234, when present, houses the electronics board 212 therein and is sealed against an amount of fluidic entry from the ambient space 210 which is likely to damage the electronics board 212 (e.g., may be completely sealed or may instead permit a de minimis amount of fluid entry which the electronics board 212 can tolerate without harm). Accordingly, the electronics board 212 can be protected from damage due to fluid contact (intentional or unintentional), which may assist with decontamination of the microplate lid 102.

The plurality of directing lumens 108, as previously mentioned, is at least partially defined by the cover plate 216. That is, some nonzero portion of each of the plurality of directing lumens 108 is defined by being encircled by a respective plate throughhole 214. Each directing lumen 108 corresponds to a respective plate throughhole 214. Since the term “lumen” refers only to a cavity or bore (i.e., a void, not a structure), it should be noted that each directing lumen 108 is defined herein by its surrounding/defining structures such as the board throughhole 214, plate throughhole 218, plate-board throughhole pair 220, base throughhole 224, plate-board-base throughhole stack 226, intermediate throughhole 230, lid throughhole 232, or some combination thereof. Each directing lumen 108 cancan also or instead be bounded laterally by a directing wall 236 carried by, and extending downward from, the cover plate 216. When present, the directing walls 108 can extend through the board throughholes 214 to entirely laterally separate the directing lumens 108 from the board throughholes 214, the plate throughholes 218, the plate-board throughhole pairs 220, the base throughholes 224, the plate-board-base throughhole stacks 226, the intermediate throughholes 230, the lid throughholes 232, or some combination thereof. Through use of the directing walls 108, the pipette tip can be positioned as desired with respect to the wells 106, as will be discussed below.

Whether or not directing walls 108 are present, the microplate lid 102 can include a bottom plate 238 which includes a plurality of bottom throughholes 240, with each bottom throughhole 240 corresponding to a respective lid throughhole 232 The bottom plate 238, when present, may be located directly beneath, and can extend parallel to, the base plate 222. Some feature of the bottom throughholes 240, such as the small upward-extending walls shown, can be configured for cooperative engagement with the directing walls 108 to form a “tunnel” through the microplate lid 102.

The microplate lid 102, and components thereof, may be made from any suitable material or combination of materials, including, but not limited to, plastics (rigid, flexible, or film), glass, epoxy, printed circuit boards (“PCBs”, such as FR-4 or any other composite material composed of woven fiberglass cloth with an epoxy resin binder), and metal (e.g. stainless steel). The microplate lid 102 can be disposable, sterilizable or otherwise reusable, or can include some combination of components each having one of these disposable/reusable abilities. For example, and particularly when the electronics board 212 is housed within a board cavity 234 provided by the base plate 222 and the intermediate plate 228 to form a subassembly, a separate cover plate 216 can be provided. The cover plate 216 (and directing walls 236, when present) thus can insulate the electronics board 212 subassembly from physical contact with the pipette tip. A bottom plate 238 can also be provided, to separate the electronics board 212 subassembly from physical contact with the microplate 104. The cover plate 216, bottom plate 238, and electronics board 212 subassembly can be sterilizable in any desired manner, such as, but not limited to, autoclaving and wipedowns with decontaminating fluids. For example, the cover plate 216, bottom plate 238, base plate 222, and/or intermediate plate 228 can be made from a material that does not deteriorate from, and may be decontaminated by, contact with bleach, alcohol, ethanol, similar cleaning fluids, solutions thereof, or combinations thereof. Particularly if the electronics board 212 subassembly is sterilizable for reuse, the cover plate 216 and any bottom plate 238 can be disposable, for ease in efficiently and economically presenting a “clean” surface to the pipette and/or microplate 104 for each use of the microplate lid 102. In another example, the entire microplate lid 102 can be provided as a single unit, which may be completely sealed to protect the electronics board 212 from fluid damage, for reuse or discarding as a single item.

The microplate lid 102, or components thereof, may be designed to include some feature to aid with firm attachment onto the microplate 104 or onto other components of the assembly 100. The cover plate 216 can be configured to attach to the electronics board 212 subassembly to be easily handled together in a unitary manner. These attachments can be permanent or reversible, and can be accomplished in any suitable manner such as, but not limited to, a “snap-on” type frictional or interference fit.

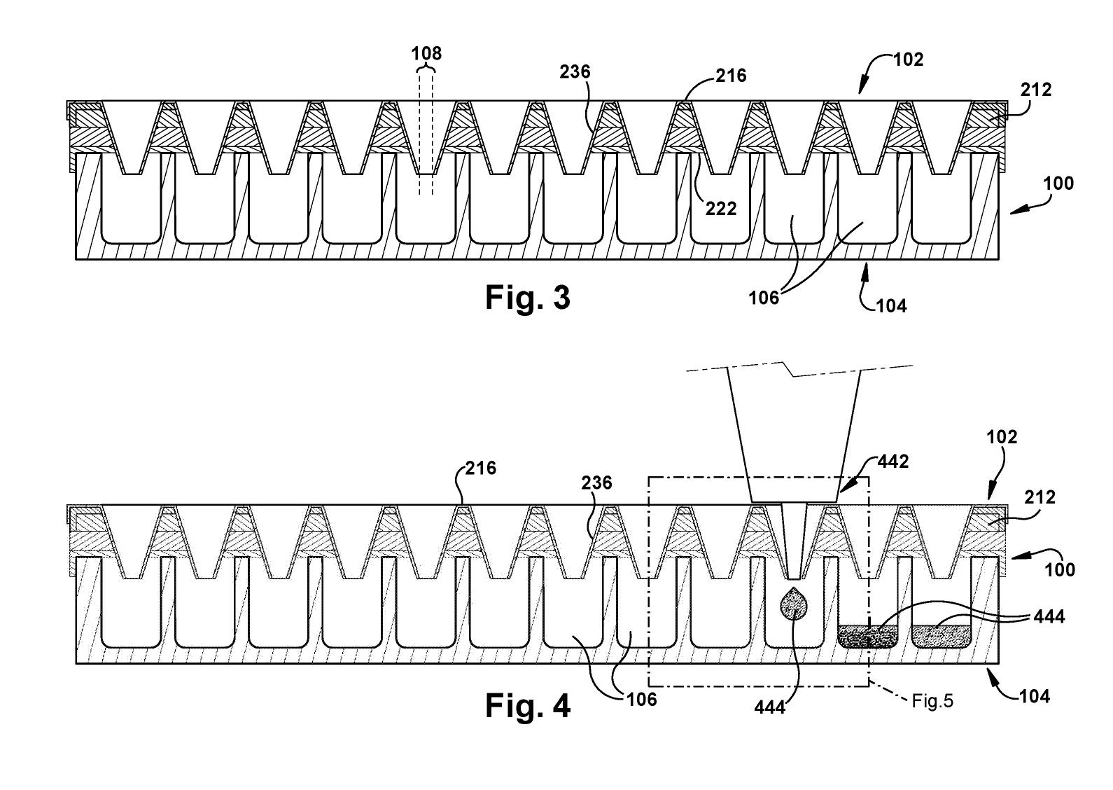

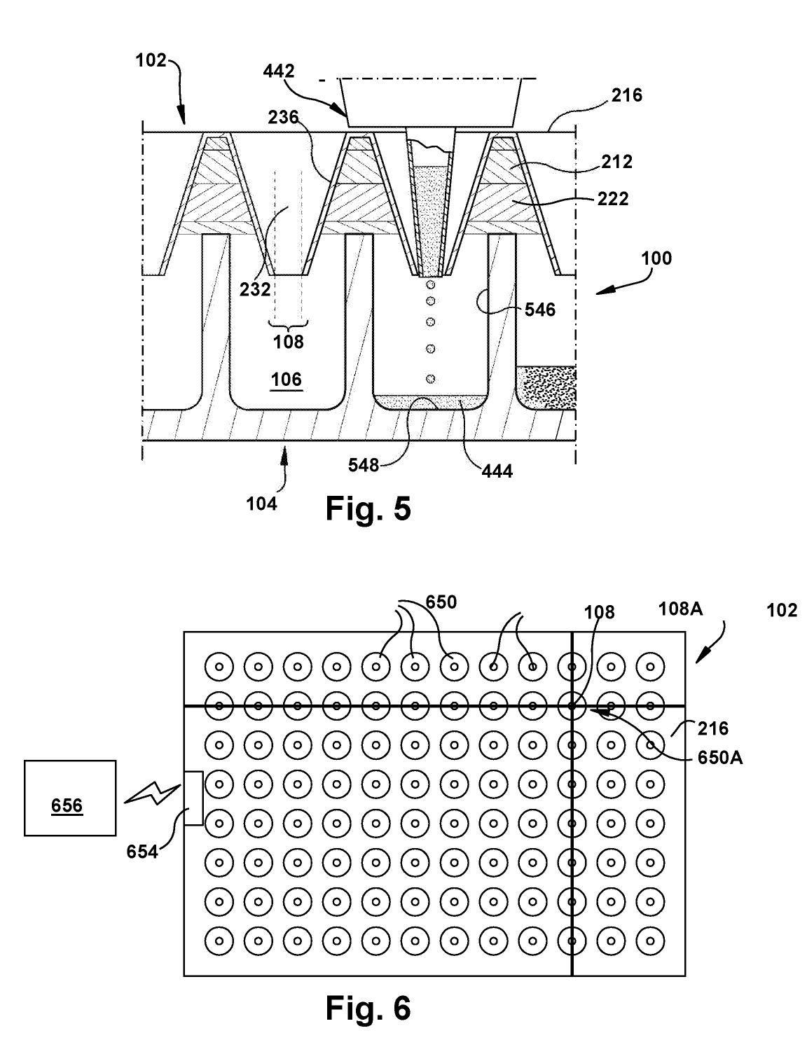

FIG. 3 illustrates an assembled view of the assembly 100 shown exploded in FIG. 2. In FIG. 3, the microplate lid 102 is situated atop the microplate 104. FIG. 4 then depicts a pipette tip 442 associated with the assembly 100 which is sequentially dispensing a fluid 444 into the wells 106. As shown in FIG. 4, the fluid 444 has already been dispensed into the first and second wells 106 from the right, and is in the process of being dispensed into the third well 106 from the right. FIG. 5 is an enlarged view similar to the indicated area “5” in FIG. 4.

The microplate lid 102 may be helpful when dealing with very small quantities or volumes of fluid 444. For example, the microplate lid 102 can be used in conjunction with dispensing nanoliter- and/or picoliter-scale amounts of material. While current commercially-available microplates 104 and accessories (such as pipettors/pipettes) allege accuracy down to approximately half-microliter scale, it has been found that dispensing of fluids from known pipettors/pipettes is only accurate up to about two microliters. At these very small scales, static forces and angled pipette tip 442 insertions can result in significant quantities of the fluid 444 being “wasted” by coating the sidewalls 546 of the wells 106. This “wasted” fluid is not available for use in the wells 106, and may result in unwanted or misleading test results, for example, particularly when combined with known small-scale accuracy issues of pipette tips 442. Accordingly, the directing lumens 108 (one shown in dash-dot line in FIG. 5) and surrounding structures of the microplate lid 102 can be configured to direct the pipette tip 442 longitudinally and/or laterally to assist with dispensing of a desired quantity of fluid 444 directly toward a bottom surface 548 of each well 106, while avoiding contact between the fluid 444 and the sidewalls 546 of the wells 106. The microplate lid 102 can direct the pipette tip 442 longitudinally by admitting the pipette tip 442 into the volume of the well 106, such as into the “negative pen-to-paper spacing” shown in FIG. 5, where the pipette tip 442 extends entirely through the lid throughhole 232. The lateral dimensions of the directing lumen 108 can be designed to prevent insertion of a tapering pipette tip 442 beyond a predetermined amount. Lateral direction of the pipette tip 442 can be provided by contact between the directing wall 236 and the pipette tip 442, and/or simply through location of the directing lumen 108 in lateral relation to the sidewalls 546 of the microplate 104.

It is contemplated that a single microplate lid 102 can be “adjustable” for different microplate 104 use situations. For example, a plurality of cover plates 216, each having differently configured plate throughholes 218, can be provided—perhaps a “dry” cover plate 216 can have larger plate throughholes 218 and thus a larger directing lumen 108 effective size, thus permitting deeper penetration by a tapered pipette tip 442, than a “wet” cover plate 216 (with the shallower penetration in the “wet” version helping to keep a pipette tip 442 from contacting fluid 444 already present within the wells 106). In another example, a single microplate lid 102 can include a plurality of directing lumen 108 effective sizes, either in different lateral locations along the microplate lid 102 or even in a “multi-use” microplate lid 102 which admits a pipette tip 442 to one depth when “face up” and to a different depth when reversed to a “face down” orientation.

Turning to the top view of FIG. 6, the microplate lid 102 can include a plurality of user-perceptible array indicators 650 provided to the electronics board 212. Each array indicator 650 is associated with a different directing lumen 108 (i.e., a different board throughhole 214, plate throughhole 218, plate-board throughhole pair 220, base throughhole 224, plate-board-base throughhole stack 226, intermediate throughhole 230, lid throughhole 232, or some combination thereof, depending upon microplate lid 102 configuration) than is every other array indicator 650. For most use environments, each directing lumen 108 will have its own array indicator 650.

The array indicators 650 may be configured to provide a signal or other indication which is perceptible to a user, with or without a perception aid (such as special glasses)—this type of output of the array indicators 650 will be characterized herein as a “user-perceptible indication”. For example, a user-perceptible indication can include at least one of visible light (of at least one color), non-visible light (e.g., infrared and/or ultraviolet), an audible tone, or any other indication which allows a user to perceive a difference between an “actuated” and a “non-actuated” array indicator 650. For many use environments, the array indicators 650 will include at least one light-emitting diode (“LEDs”), but can also or instead include liquid crystal display technology and/or fiber optics or other light guide structures. Non-visible spectrum light, such as infrared and/or ultraviolet, can be particularly useful if the fluid 444 or another substance used in the microplate 104 work is light-sensitive, or if the pipette tip 442 is slightly fluorescent. The array indicators 650 can be actuated in any desired manner. For example, when the array indicators 650 are LEDs arranged in rows and columns, the row can be powered and the column grounded for a particular LED at the intersection of that row/column to turn on.

The array indicators 650 may be used in any desired manner to selectively indicate at least one directing lumen 108. (A “selective” indication, as used herein, is one which is actuated as desired to convey particular information.) For example, and as shown in FIG. 6, a particular directing lumen 108A is of interest. The specific array indicator 650A associated with that directing lumen 108A can be actuated to guide the user's attention to that subject directing lumen 108A, in any manner and for any reason, such as to let the user know that fluid 444 should be dispensed into that directing lumen 108A next. At least one other of the plurality of array indicators 650 can also or instead be actuated, along with or instead of the specific array indicator 650A, to assist with conveying information to the user about the particular directing lumen 108A. For example, the array indicators 650 along the “row” and/or “column” of that directing lumen 108A can be actuated, either steadily or in an “airport runway” type sequential manner, to draw the user's attention to the subject directing lumen 108A.

A relatively simple implementation of the microplate lid 102 can include one-at-a-time actuation of the array indicators 650 to provide a “binary” type on/off signal or indication of a single color for a single directing lumen 108. A more complex implementation can involve simultaneous actuation of a plurality of the array indicators 650 to convey additional information, such as letting a user know which of the wells 106 have received fluid 444 (e.g., via red LED illumination), which have not (e.g., via green LED illumination), and which directing lumen 108 should be the next one accessed with the pipette tip 442 (e.g., via blinking and/or white LED illumination). One of ordinary skill in the art will be able to provide a suitable indication scheme for a particular use environment which apprises a user of desired information regarding the microplate 104, with the assistance of the available types of user-perceptible indications provided by the array indicators 650.

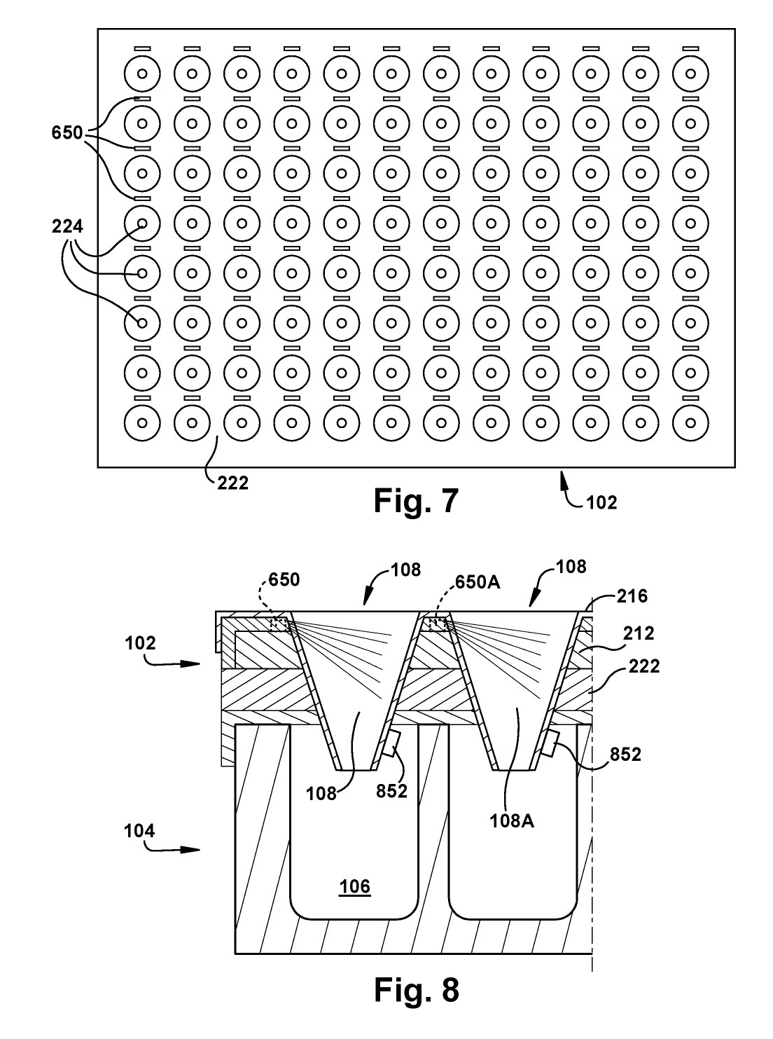

FIG. 7 is a bottom view of the microplate lid 102, showing an underside of the base plate 222. Each base throughhole 224 has an associated array indicator 650, as previously mentioned. The array indicators 224 may be located on the electronics board 212, the base plate 222, the cover plate 216, or any other structure of the microplate lid 102. However, for some use environments, it will be desirable for the array indicators 650 to be protected from contact with fluid 444 in the ambient space 210 and/or the wells 106, such as by being sealed inside the board cavity 234.

In some examples, it is also desirable for the array indicators 650 to be configured (e.g., positioned, shielded, and/or masked) to clearly indicate, as shown in FIG. 8, only a single desired directing lumen 108A. If light from one array indicator 650 were to “bleed over” into directing lumens 108 adjacent to the particular subject directing lumen 108A, confusion and potential adverse effects can result. To that end, the cover plate 216, the base plate 222, the electronics board 212, or any other structure of the microplate lid 102 can include transparent portions, translucent portions, opaque portions, apertures, and/or any other desired features to assist with affecting user perception of the actuation/non-actuation state of the array indicators 650 to reduce the likelihood of a mistaken “indication” of a directing lumen 108 that is not the desired subject directing lumen 108A. For example, if the array indicators 650 are LEDs, the LEDs can be masked via transparent and opaque portions of remaining microplate lid 102 structures to specifically direct light energy toward each associated directing lumen 108.

As shown in FIG. 8, a plurality of aperture sensors 852 can be provided to the electronics board 212 or to any other portion of the microplate lid 102. For example, an aperture sensor 852 could include one or more of a distance sensor, a sensor equipped to detect matter within a corresponding directing lumen 108, a light sensor, or any other desired type of sensor. When present, each aperture sensor 852 may be associated with a corresponding directing lumen 108 (i.e., a different board throughhole 214, plate throughhole 218, plate-board throughhole pair 220, base throughhole 224, plate-board-base throughhole stack 226, intermediate throughhole 230, lid throughhole 232, or some combination thereof, depending upon microplate lid 102 configuration) for indicating at least one of the presence and absence of a structure, such as a pipette tip 442, extending at least partially through the directing lumen 108. To that end, the aperture sensors 852 can include photoelectric, conduction, or any other sensing capacity. Additional sensors (not shown), of any suitable type, can be provided to indicate other conditions of the assembly 100 or portions thereof, such as, but not limited to, sensors for detecting the presence of fluid 444 in the wells 106.

Returning to FIG. 6, the electronics board 212 can include an input/output device (shown schematically at 654) for transmitting electronic signals between different components of the apparatus 100 and a remotely located control device 656. The term “electronic signals” encompasses, but is not limited to, power transfer, control signals from the control device 656, and reporting signals from the microplate lid 102 or components thereof. This signal transmission is represented schematically by the “lightning bolt” icon in FIG. 6, and can be done in any suitable wired and/or wireless manner. For example, a USB interface or other suitable component can be an input/output device 654, allowing electronic signals to be transmitted via wire between the control device 656 and the microplate lid 102.

It should be noted that when the connection is wired, such as via a USB connector, sealing of the board cavity 234 may be complicated by the need for the wire to extend between the electronics board 212 and the ambient space 210. Thus, particularly when the electronics board 212 subassembly is intended for sterilization and reuse, a wireless connection may be desirable, such as via induction and/or Bluetooth signaling.

Regardless of type, the input/output device 654, when present, may assist with transmitting electronic signals between at least a chosen two items from some combination of at least one of the plurality of array indicators 650, at least one of the plurality of aperture sensors 852, an onboard battery (not shown) associated with the electronics board 212, and a remotely located control device 656, for any reason and in any desired configuration. The electronic signals can include real-time or pre-programmed instructions for actuating or changing configuration/type of at least one array indicator 650, readings from the aperture sensors 852 relating to sensed presence of a structure (such as the pipette tip 442) in the directing lumen 108, fluid 444 presence, fluid 444 dispensed, time fluid 444 in well 106, local fluid 444 temperature, general error, specific error, pipette tip 442 insertion depth, any type of warning, correct pipette alignment with directing lumen 108, and/or any other desired signals.

The microplate lid 102 will be useful in helping to direct a pipette tip 442 relative to a microplate 104. Thus, the assembly 100 can be used as follows. A microplate lid 102, such as one configured at least partially as described above, can be placed atop the microplate 104 with at least one directing lumen 108 aligned, and in fluid communication, with a respective well 106 of the microplate 104. With a chosen array indicator 108A, a user-perceptible signal can be provided to indicate at least a portion of a selected directing lumen 108 (i.e., a different board throughhole 214, plate throughhole 218, plate-board throughhole pair 220, base throughhole 224, plate-board-base throughhole stack 226, intermediate throughhole 230, lid throughhole 232, or some combination thereof, depending upon microplate lid 102 configuration) to a user. As an example, an area of the microplate lid 102 corresponding to the selected directing lumen 108 may be illuminated.

The pipette tip 442 is initially accepted into the selected directing lumen 108, or portion thereof. The initially accepted pipette tip 442 is then inserted entirely through the plate-board throughhole pair 220 associated with that directing lumen 108. The microplate lid 102, or at least one structure thereof, is used to urge the pipette tip 442 into a desired lateral position with respect to a corresponding well 106.

At any time relative to the insertion and lateral positioning of the pipette tip 442 with respect to the selected directing lumen 108, a plurality of array indicators 650 can be actuated to each exhibit different user-perceptible signals. For example, red or green LEDs can be used to indicate empty or full wells 106, respectively. Regardless of the signal scheme, the different user-perceptible signals can be employed according to a predetermined “code” to indicate a corresponding plurality of microplate conditions to the user.

The presence of a pipette tip 442 at least partially through the selected directing lumen 108 can be detected, such as via the aforementioned aperture sensors 852. Actuation of the pipette tip 442 can then be authorized (such as by some combination of the input/output device 654 and the control device 656) responsive to the detected presence of the pipette tip 42 through the selected directing lumen 108.

The microplate lid 102 can form a portion of a “smart” system that prompts the user to insert the pipette tip 442 into a selected directing lumen 108A, detects whether the pipette tip 442 is inserted into the proper directing lumen 108A, and then reacts accordingly. If the pipette tip 442 is inserted into a different directing lumen 108 than that desired, the system can alert the user of the error in any desired manner. When the pipette tip 442 is inserted into the desired directing lumen 108A, the system can actuate the pipette tip 442 to dispense a predetermined amount of fluid 444 into the well 106 corresponding to that directing lumen 108A. (This may be helpful in avoiding user inconvenience related to repeated pipette actuation.) The system can then deactivate or change the array indicator 650 to communicate to the user that the dispensation for that directing lumen 108A is complete and/or that the pipette tip 442 can be removed from the directing lumen 108A. The system may sense that the pipette tip 442 has been removed from the directing lumen 108A, and may then start the cycle again with a different desired directing lumen 108.

It is contemplated that the microplate lid 102 can include onboard processing capabilities and act at least partially autonomously in controlling the array indicators 650. In another example, at least a portion of the control of the features and capabilities of the microplate lid 102 can be done remotely, via a control device 656 which may also include some passive or active connections to other tools or devices for that particular use environment.

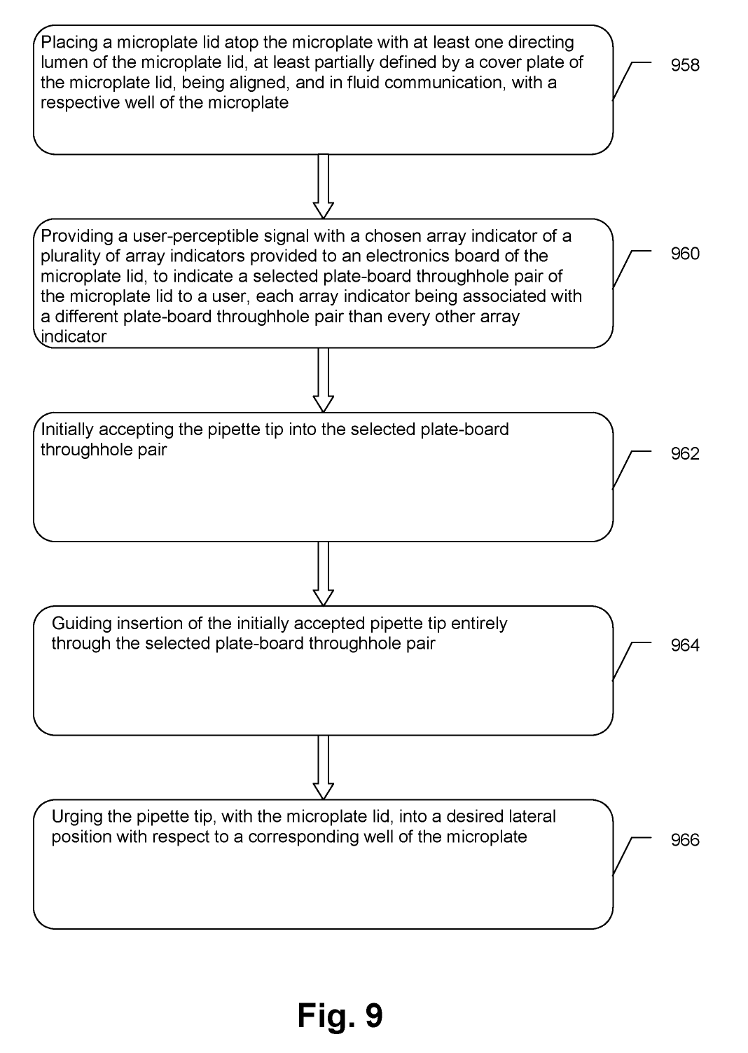

FIG. 9 is a flowchart depicting an example method of directing a pipette tip 442 relative to a microplate 104. In first action block 958, a microplate lid 102 is placed atop the microplate 104 with at least one directing lumen 108 of the microplate lid 102 being aligned, and in fluid communication, with a respective well 106 of the microplate 104. Each directing lumen 108 may be at least partially defined by a cover plate 216 of the microplate lid 102. In second action block 960, a user-perceptible signal is provided with a chosen array indicator 108A of a plurality of array indicators 108 provided to an electronics board 212 of the microplate lid 102, to indicate a selected plate-board throughhole pair 220 of the microplate lid 102 to a user. Each array indicator 108 is associated with a different plate-board throughhole pair 220 than every other array indicator 108. In third action block 962, the pipette tip 442 is initially accepted into the selected plate-board throughhole pair 220. In fourth action block 964, insertion of the initially accepted pipette tip 442 entirely through the selected plate-board throughhole pair 220 is guided. In fifth action block 966, the pipette tip 442 is urged with the microplate lid 102 into a desired lateral position with respect to a corresponding well 106 of the microplate 104.

Relative terms used to describe the structural features of the figures illustrated herein, such as above and below, up and down, first and second, near and far, etc., are in no way limiting to conceivable implementations. For instance, where examples of the structure described herein are described in terms consistent with the figures being described, and actual structures can be viewed from a different perspective, such that above and below may be inverted, e.g., below and above, or placed on a side, e.g., left and right, etc. Such other interpretations are fully embraced and explained by the figures and description provided herein. When a plurality of elements pictured in a Figure are at least substantially the same, only a subset of them may be labeled with element numbers for clarity, but no significance should be attached to the presence or absence of an element number on specific ones of that plurality of elements. While the fluid 444 is described herein as being “dispensed”, one of ordinary skill in the art will be able to interpret the described structures and actions for use with any other action (e.g., collection of fluid) by a pipette during microplate 104 use.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include at least one such element, neither requiring nor excluding two or more such elements. As used herein, the term “includes” means includes but not limited to, and the term “including” means including but not limited to. The term “based on” means based at least in part on.

What is claimed is:

1. A microplate lid, comprising:
an electronics board including a plurality of board throughholes corresponding to well locations of a microplate;
a cover plate including a plurality of plate throughholes corresponding to respective board throughholes to define a plurality of plate-board throughhole pairs, the cover plate being located atop the electronics board;
a plurality of directing lumens at least partially defined by the cover plate, each directing lumen corresponding to a respective plate throughhole; and
a plurality of user-perceptible array indicators provided to the electronics board, each array indicator being associated with a different plate-board throughhole pair than every other array indicator.

2. The microplate lid of claim 1, wherein each directing lumen is bounded by a directing wall carried by, and extending downward from, the cover plate, the directing walls extending through the board throughholes to separate the directing lumens from the board throughholes.

3. The microplate lid of claim 1, including a plurality of aperture sensors provided to the electronics board, each aperture sensor being associated with a corresponding plate-board throughhole pair for indicating at least one of the presence and absence of a structure extending at least partially through the plate-board throughhole pair.

4. The microplate lid of claim 1, including a base plate including a plurality of base throughholes corresponding to respective plate-board throughhole pairs to define a plurality of plate-board-base throughhole stacks at least partially surrounding respective directing lumens, the base plate being located beneath the electronics board.

5. The microplate lid of claim 4, including an intermediate plate including a plurality of intermediate throughholes corresponding to respective plate-board-base throughhole stacks to at least partially define a plurality of lid throughholes, each lid throughhole at least partially defining a corresponding directing lumen, the intermediate plate being located longitudinally between the cover plate and the electronics board.

6. The microplate lid of claim 5, wherein the electronics board is housed within a board cavity cooperatively defined by the intermediate plate and the base plate, the board cavity being sealed against fluidic entry from an ambient space.

7. The microplate lid of claim 1, wherein the electronics board includes an input/output device for transmitting electronic signals between the plurality of array indicators and a remotely located control device.

8. The microplate lid of claim 3, wherein the electronics board includes an input/output device for transmitting electronic signals between at least two of the plurality of array indicators, the plurality of aperture sensors, and a remotely located control device.

9. The microplate lid of claim 1, wherein the plate-board throughhole pairs are aligned, and in fluid communication, with respective wells of a microplate when the microplate lid is located atop the microplate.

10. A microplate lid, comprising:
an electronics board including a plurality of board throughholes corresponding to well locations of a microplate, the board throughholes being arranged in a predetermined array layout corresponding to well locations of a microplate, the electronics board being parallel to a lateral plane;
a cover plate including a plurality of plate throughholes corresponding to respective board throughholes to define a plurality of plate-board throughhole pairs arranged in the predetermined array layout, the cover plate being located longitudinally above the electronics board;
a base plate including a plurality of base throughholes corresponding to respective plate-board throughhole pairs to define a plurality of plate-board-base throughhole stacks arranged in the predetermined array layout, the base plate being located directly beneath the electronics board;
an intermediate plate including a plurality of intermediate throughholes corresponding to respective plate-board-base throughhole stacks to at least partially define a plurality of lid throughholes arranged in the predetermined array layout, each lid throughhole at least partially defining a corresponding directing lumen, the intermediate plate being interposed directly longitudinally between the cover plate and the electronics board;
a bottom plate including a plurality of bottom throughholes at least partially defining the plurality of lid throughholes, the bottom plate being interposed directly longitudinally beneath the base plate; and
a plurality of user-perceptible array indicators provided to the electronics board, each array indicator being associated with a different directing lumen than every other array indicator; wherein
each directing lumen is bounded by a directing wall carried by, and extending downward from, the cover plate, the directing walls extending through the board throughholes to entirely laterally separate the directing lumens from the board throughholes, the base throughholes, and the intermediate throughholes.

11. The microplate lid of claim 10, wherein the electronics board includes an input/output device for transmitting electronic signals between the plurality of array indicators and a remotely located control device.

12. A method of directing a pipette tip relative to a microplate, the method comprising:
placing a microplate lid atop the microplate with at least one directing lumen of the microplate lid, at least partially defined by a cover plate of the microplate lid, being aligned, and in fluid communication, with a respective well of the microplate;
providing a user-perceptible signal with a chosen array indicator of a plurality of array indicators provided to an electronics board of the microplate lid, to indicate a selected plate-board throughhole pair of the microplate lid to a user, each array indicator being associated with a different plate-board throughhole pair than every other array indicator;
initially accepting the pipette tip into the selected plate-board throughhole pair;
guiding insertion of the initially accepted pipette tip entirely through the selected plate-board throughhole pair; and
urging the pipette tip, with the microplate lid, into a desired lateral position with respect to a corresponding well of the microplate.

13. The method of claim 12, wherein providing a user-perceptible signal includes illuminating an area of the microplate lid corresponding to the selected plate-board throughhole.

14. The method of claim 12, including:
detecting the presence of a pipette tip at least partially through the selected plate-board throughhole; and
authorizing actuation of the pipette tip responsive to the detected presence of the pipette tip through the selected plate-board throughhole.

15. The method of claim 12, including
selectively actuating a plurality of array indicators to each exhibit different user-perceptible signals; and
with the different user-perceptible signals, indicating a corresponding plurality of microplate conditions to the user.
